(19) United States
(12) Patent Application Publication
(10) Pub. No.: US 2026/0321938 A1
(43) Pub. Date: Oct. 15, 2026

(54) APPARATUS AND METHOD FOR INJECTING ELECTROLYTE INTO BATTERY CELL

(71) Applicant: SK ON CO., LTD., Seoul (KR)

(72) Inventor: Ji Hyeon KIM, Daejeon (KR)

(21) Appl. No.: 19/466,523

(22) Filed: Feb. 2, 2026

(30) Foreign Application Priority Data
Feb. 4, 2025 (KR) 10-2025-0014037

(51) Int. Cl. H01M 50/609

(52) U.S. Cl. CPC H01M 50/609

(57) ABSTRACT

Proposed is an apparatus and method for injecting an electrolyte into a battery cell. The apparatus comprises at least one tray provided to receive a case with an electrode assembly inserted therein, at least one first hopper provided to inject the electrolyte into the case therethrough, at least one level sensor provided to measure the level of the electrolyte injected into the case, and a controller configured to be informed of the electrolyte level from the level sensors and to measure the degree of impregnation of the electrolyte by comparing the electrolyte level with a reference level.

### CROSS REFERENCE TO RELATED APPLICATION

The present application claims priority to Korean Patent Application No. 10-2025-0014037, filed Feb. 4, 2025, the entire contents of which is incorporated herein for all purposes by this reference.

### TECHNICAL FIELD

The present disclosure relates to an apparatus and method for injecting an electrolyte into a battery cell.

### BACKGROUND

A secondary battery is a rechargeable battery that may be charged and discharged. Batteries are used in various devices such as electric vehicles, energy storage systems, and portable electronic devices. Batteries are manufactured on a cell basis. A single battery cell may be used in a portable electronic device, or a plurality of battery cells may be assembled into a module or a pack for use in an electric vehicle or an energy storage system. A battery has a structure in which an electrode assembly composed of a cathode, an anode, and a separator is immersed in an electrolyte inside a case. The electrolyte may provide a path for ion movement between the anode and the cathode. The electrolyte may comprise a lithium salt and an organic solvent.

### SUMMARY

According to an aspect of the present disclosure, provided is an apparatus and method for injecting an electrolyte into a battery cell, measuring the level of the electrolyte, and confirming the degree of impregnation of the electrolyte in the battery cell.

According to an aspect of the present disclosure, provided is an apparatus and method for injecting an electrolyte into a battery cell and, in accordance with the level of the electrolyte, applying ultrasonic vibration so as to improve the degree of impregnation of the electrolyte in the battery cell.

The apparatus and method for injecting an electrolyte into a battery cell according to one aspect of the present disclosure may be applied to battery manufacturing processes widely used in green technology fields such as electric vehicles, battery charging stations, and solar and wind power generation utilizing batteries.

The apparatus and method for injecting an electrolyte into a battery cell according to one aspect of the present disclosure may be applied to battery manufacturing processes used for eco-friendly electric vehicles (EVs) and hybrid vehicles (HVs) aimed at suppressing air pollution and greenhouse gas emissions to prevent climate change.

According to an aspect of the present disclosure, an apparatus for injecting an electrolyte into a battery cell comprises: at least one tray provided to receive a case with an electrode assembly inserted therein; at least one first hopper provided to inject the electrolyte into the case therethrough; at least one level sensor provided to measure the level of the electrolyte injected into the case; and a controller configured to be informed of the electrolyte level from the level sensors and to measure the degree of impregnation of the electrolyte by comparing the electrolyte level with a reference level.

According to an embodiment, the apparatus for injecting an electrolyte into a battery cell may further comprise at least one weight sensor connected to a portion in the tray at which the case is received, the weight sensors being configured to measure the weight of the case.

According to an embodiment, the controller may be configured to measure the weight of the electrolyte injected into the case using the weight received from the weight sensor, and when the amount of the electrolyte injected into the case is smaller than a reference amount, to allow for an additional supply of the electrolyte.

According to an embodiment, the apparatus for injecting an electrolyte into a battery cell may further comprise a sensor mover provided to move the level sensor to an inlet formed in the case.

According to an embodiment, the controller may be configured to control the sensor mover such that, while the first hopper injects the electrolyte through the inlet, the level sensor is spaced apart from the inlet, and after the first hopper injects the electrolyte, the level sensor is moved to the inlet.

According to an embodiment, the apparatus for injecting an electrolyte into a battery cell may further comprise a vibration applying section connected to the tray and in contact with a side surface of the case, the vibration applying section being configured to apply ultrasonic vibration to the case.

According to an embodiment, the controller may be configured to control the vibration applying section to apply ultrasonic vibration to the case when the level of the electrolyte injected into the case exceeds the reference level.

According to an embodiment, the controller may be configured to determine whether the extent to which the level of the electrolyte injected into the case exceeds the reference level corresponds to one of a plurality of preset levels, and to control the vibration applying section to apply vibration to the case in response to the corresponding preset level.

According to an embodiment, the vibration applying section may comprise a wall connected to the tray and extending to a middle portion of the case therefrom, and a plurality of vibrators connected to the wall to face the case.

According to an embodiment, the controller may be configured to, when the extent to which the level of the electrolyte injected into the case exceeds the reference level corresponds to a first preset level, control the vibration applying section to apply a first-level of vibration; when the extent corresponds to a second preset level greater than the first preset level, control the vibration applying section to apply a second-level of vibration; and when the extent corresponds to a third preset level greater than the second level, control the vibration applying section to apply a third-level of vibration.

According to another aspect of the present disclosure, a method of injecting an electrolyte into a battery cell comprises: while a case with an electrode assembly accommodated therein is received in a tray, injecting, through a first hopper, the electrolyte into the case; measuring, by a level sensor, the level of the electrolyte injected into the case; and receiving, by a controller, the electrolyte level from the level sensor and measuring the degree of impregnation of the electrolyte in the case by comparing the electrolyte level with a reference level.

According to an embodiment, the method may further comprise: before the electrolyte is injected into the case, measuring, by a weight sensor connected to a portion in the tray at which the case is received, the weight of the case; after the electrolyte is injected into the case, measuring, by the weight sensor, the weight of the case with the electrolyte injected therein; calculating, by the controller, the weight of the electrolyte injected into the case by subtracting the weight of the case before the electrolyte is injected into the case from the weight of the case after the electrolyte is injected into the case, which is received from the weight sensor; comparing, by the controller, the weight of the electrolyte injected into the case with a reference weight; and, when the weight of the electrolyte is smaller than the reference weight, controlling, by the controller, the first hopper to additionally inject an amount of electrolyte corresponding to the difference between the weight of the electrolyte and the reference weight.

According to an embodiment, after additional injection of the electrolyte, the controller may be configured to measure the weight of the case with the electrolyte additionally injected therein, and when the weight of the electrolyte is equal to or greater than the reference weight, to measure the level of the electrolyte.

According to an embodiment, the step of injecting the electrolyte may be performed in a state in which the level sensor is kept spaced apart from an inlet formed in the case while the controller controls a sensor mover to move the level sensor to the inlet so that the first hopper injects the electrolyte through the inlet.

According to an embodiment, the step of measuring the level of the electrolyte may be performed while the controller controls the sensor mover to move the level sensor to the inlet.

According to an embodiment, the step of measuring the degree of impregnation of the electrolyte may comprise comparing, by the controller, the level of the electrolyte injected into the case with a reference level, and determining, by the controller, the electrolyte level as one of a plurality of preset levels.

According to an embodiment, the method may further comprise controlling, by the controller, a vibration applying section, connected to the tray and in contact with a side surface of the case, to apply ultrasonic vibration to the case in response to the determined preset level.

According to an embodiment, the step of applying vibration may comprise: when the extent to which the level of the electrolyte injected into the case exceeds the reference level corresponds to a first preset level, controlling, by the controller, the vibration applying section to apply a first-level of vibration; when the extent corresponds to a second preset level greater than the first preset level, controlling, by the controller, the vibration applying section to apply a second-level of vibration; and when the extent corresponds to a third preset level greater than the second preset level, controlling, by the controller, the vibration applying section to apply a third-level of vibration.

According to an embodiment, the plurality of vibrators may comprise a plurality of first vibrators provided to apply a first frequency range of vibration, and a plurality of second vibrators provided to apply a second frequency range of vibration whose frequency range is higher than the first frequency range of vibration, wherein the plurality of first vibrators are arranged in two rows of first vibrators located at the middle-lower portion and middle-upper portion of the wall so that the first vibrators are spaced apart at regular intervals, and the plurality of second vibrators is arranged in three rows of second vibrators located at the lower, middle, and upper portions of the wall so that the plurality of second vibrators is spaced apart at regular intervals.

According to an embodiment, the first-level of vibration may be such that the vibration by the two rows of first vibrators is applied to the case for a first period of time.

According to an embodiment, the second-level of vibration may be such that the vibration by the two rows of second vibrators located at the upper and middle portions of the wall is applied to the case for a second period of time, and sequentially, the vibration by the two rows of first vibrators is applied to the case for a third period of time.

According to an embodiment, the third-level of vibration may be such that the vibration by the row of second vibrators located at the upper portion of the wall and the vibration by the two rows of first vibrators are applied to the case for a fourth period of time, and sequentially, the vibration by the two rows of second vibrators located at the middle and lower portions of the wall is applied to the case for a fifth period of time, and the vibration by the two rows of first vibrators is applied to the case for a sixth period of time.

The features and advantages of the present disclosure will become more apparent from the following detailed description with reference to the accompanying drawings.

Prior to this, terms and words used in the present specification and claims shall not be interpreted in a conventional or dictionary sense. Based on the principle that an inventor may properly define terms to best describe his/her invention, the terms and words shall be construed in the meaning and concept consistent with the technical spirit of the present disclosure.

According to an embodiment of the present disclosure, the degree to which the electrode assembly is immerged into the electrolyte may be improved.

According to an embodiment of the present disclosure, the degree of immersion of the electrode assembly into the electrolyte may be detected without disassembling the battery cell.

According to an embodiment of the present disclosure, changes in the electrolyte level during the battery cell manufacturing process may be measured and used as criteria for determining process changes according to the battery cell model.

### BRIEF DESCRIPTION OF THE DRAWINGS

The above and other objectives, features and advantages of the present disclosure will be more clearly understood from the following detailed description when taken in conjunction with the accompanying drawings, in which:

FIG. 1 is a flowchart illustrating an overall process in which an apparatus for injecting an electrolyte into a battery cell, according to an embodiment, injects the electrolyte;

FIG. 2 is a diagram illustrating an apparatus for injecting an electrolyte into a battery cell according to an embodiment.

FIG. 3 is a diagram illustrating a state in which a level sensor, according to an embodiment, measures the level of the electrolyte injected into a case;

FIG. 4 is a diagram illustrating that a controller, according to an embodiment, determines the electrolyte level as one of a plurality of preset levels;

FIG. 5 is a diagram illustrating a vibration applying section connected to a tray according to an embodiment;

FIG. 6 is a diagram illustrating a plurality of vibrators of the vibration applying section according to an embodiment;

FIG. 7 is a diagram illustrating respective steps of a method of injecting an electrolyte into a battery cell according to an embodiment;

FIG. 8 is a diagram illustrating a state in which a case is received in a tray;

FIG. 9 is a diagram illustrating a state in which a predetermined amount of electrolyte has been transferred from a second hopper to a first hopper;

FIG. 10 is a diagram illustrating a state in which the tray moves upward and an inlet of the case is connected to the first hopper;

FIG. 11 is a diagram illustrating a state in which the electrolyte is injected from the first hopper into the case;

FIG. 12 is a diagram illustrating a state in which the tray moves downward and the level sensor measures the level of the electrolyte injected into the case;

FIG. 13 is a diagram illustrating a process of checking the injection amount of the electrolyte using a weight sensor in the method of injecting an electrolyte into a battery cell according to an embodiment; and

FIG. 14 is a diagram illustrating a process of improving the degree of impregnation using the vibration applying section in the method of injecting an electrolyte into a battery cell according to an embodiment.

### DETAILED DESCRIPTION

Hereinafter, the present disclosure will be described in detail with reference to the accompanying drawings. However, this is merely exemplary, and the present disclosure is not limited to the specific embodiments described by way of example.

Hereinafter, an embodiment of the present disclosure will be described in detail with reference to the accompanying drawings.

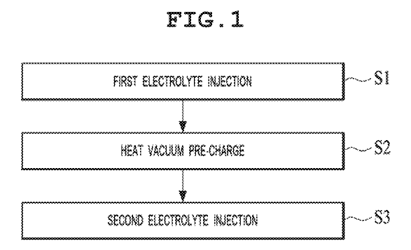

FIG. 1 is a flowchart illustrating an overall process of injecting an electrolyte 4 into a battery cell 1.

According to an embodiment, in manufacturing the battery cell 1, the process of injecting the electrolyte 4 may comprise a first electrolyte injection step S1, a heat vacuum pre-charge step S2, and a second electrolyte injection step S3. The first electrolyte injection step S1 is a step of injecting a predetermined amount of the electrolyte 4 into a case 2 with an electrode assembly 3 accommodated therein. The amount of the electrolyte 4 injected in the first electrolyte injection step S1 may be a part of the electrolyte 4 injected into the finished battery cell 1. The heat vacuum pre-charge (HVPC) step S2 is a step of creating a high-temperature and vacuum environment and perform such heat vacuum pre-charging while the electrode assembly 3 is immersed in the electrolyte 4. When the heat vacuum pre-charge step S2 is performed, the electrolyte 4 may react with the cathode 3a and the anode 3c to form a solid electrolyte interphase SEI. The second electrolyte injection step S3 is a step of injecting the remainder of the predetermined amount of electrolyte before the battery cell 1 is sealed. After performing the second electrolyte injection step S3, an inlet 2a of the case 2 may be sealed.

An apparatus 1 for injecting an electrolyte into a battery cell according to an embodiment may be used in the first electrolyte injection step S1 or the second electrolyte injection step S3.

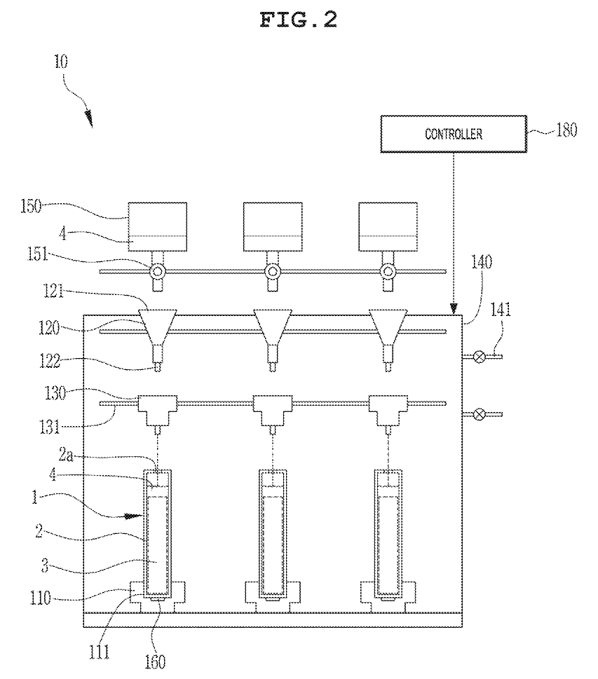

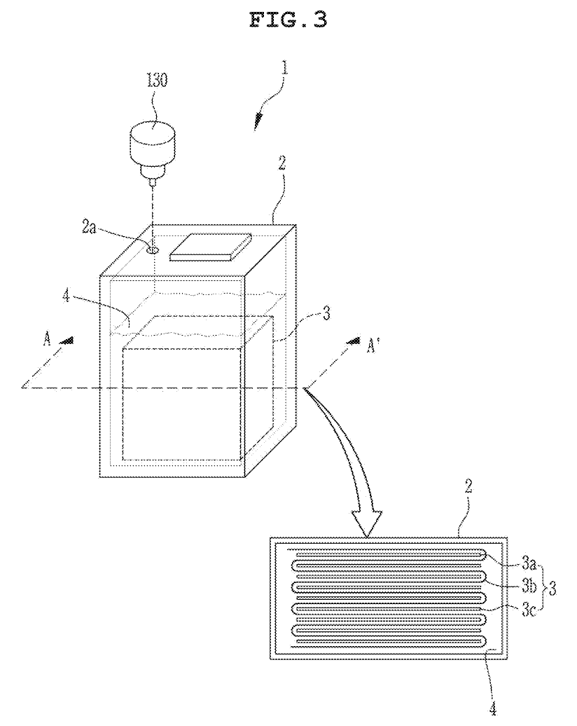

FIG. 2 is a diagram illustrating the apparatus 1 for injecting an electrolyte into a battery cell according to the embodiment. FIG. 3 is a diagram illustrating a state in which a level sensor according to an embodiment measures the level of the electrolyte 4 injected into the case 2.

The injecting apparatus may comprise at least one tray 110 provided to receive a case 2 with an electrode assembly 3 accommodated therein; at least one first hopper 120 provided to inject the electrolyte 4 into the case 2 therethrough; at least one level sensor 130 provided to measure the level of the electrolyte 4 injected into the case 2; and a controller 180 configured to receive, from the level sensor 130, the level of the electrolyte 4 and to measure the degree of impregnation of the electrolyte in the case by comparing the level of the electrolyte 4 with a reference level. The injecting apparatus 1 may further comprise a chamber 140 that internally loads the tray 110 to receive the case 2 and creates a vacuum environment; a second hopper 150 that stores the electrolyte 4; and a valve 151 that provides, from the second hopper 150, a predetermined amount of the electrolyte 4 to the first hopper 120.

The injecting apparatus 1 may inject the electrolyte 4 into the case 2 with the electrode assembly 3 accommodated therein. The case 2 with the electrode assembly 3 accommodated therein may be received in the tray 110. The injecting apparatus 1 may simultaneously inject the electrolyte 4 into a plurality of cases 2.

The tray 110 may comprise a receiving portion 111 to receive the case 2. The receiving portion 111 may be formed in a shape of recessed groove in the tray 110. The size or shape of the receiving portion 111 may be determined to correspond to the case 2. A plurality of trays 110 may be arranged in the chamber 140. The tray 110 may be moved up and down while receiving the case 2. The tray 110 may be moved up and down using a motor, gears, belts, or other physical devices.

The first hopper 120 may temporarily store a predetermined amount of electrolyte 4 and inject the electrolyte 4 into the case 2. The first hopper 120 may receive, through the valve 151, a portion of the electrolyte 4 stored in the second hopper 150. The first hopper 120 may be positioned across the inside and outside of the chamber 140. An electrolyte 4 outlet of the first hopper 120 may be located inside the chamber 140, and an electrolyte 4 inlet of the first hopper 120 may be located outside the chamber 140. A plurality of first hoppers 120 may be arranged to correspond to the number of trays 110 in the chamber 140.

The case 2 may comprise a prismatic case 2 or a cylindrical case 2 according to an embodiment. As illustrated in the enlarged cross-sectional view taken along line A-A′ in FIG. 3, an electrode assembly 3 in which a cathode 3a, a separator 3b, and an anode 3c are stacked may be accommodated in the case 2. The electrode assembly 3 is also referred to as a jelly roll.

An inlet 2a may be formed on an upper surface of the case 2. The inlet 2a is a hole formed in the case 2 to inject the electrolyte 4 therethrough while the electrode assembly 3 is accommodated in the case 2. The inlet 2a may be sized to allow insertion of an outlet 122 of the first hopper 120.

The level sensor 130 may measure the level of the electrolyte 4 injected into the case 2. The level sensor 130 may comprise a contact-type sensor or a non-contact-type sensor. The level sensor 130 may comprise an ultrasonic sensor, a laser sensor, a radio-wave sensor, a rope sensor, and the like. The level sensor 130 may provide the level of the electrolyte 4 injected into the case 2 to the controller 180. A plurality of level sensors 130 may be arranged in the chamber 140 to correspond to the number of trays 110.

The injecting apparatus 1 may further comprise a sensor mover 131 provided to move the level sensor 130 to the inlet 2a formed in the case 2. The controller 180 may be configured to control the sensor mover 131 such that while the first hopper 120 injects the electrolyte 4 through the inlet 2a, the level sensor 130 is spaced apart from the inlet 2a, and after the first hopper 120 injects the electrolyte 4, the level sensor 130 is moved to the inlet 2a.

The level sensor 130 may be moved by the sensor mover 131. The sensor mover 131 may move the position of the level sensor 130 by means of a motor, gears, belts, links, or other devices. The sensor mover 131 may move the level sensor 130 toward the electrolyte 4 inlet 2a of the case 2. The sensor mover 131 may move the level sensor 130 to a position spaced apart from the electrolyte 4 inlet 2a of the case 2.

The level sensor 130 may measure the level of the electrolyte 4 injected into the case 2 through the inlet 2a of the case 2. Because the positions of the tray 110, the case 2, and the level sensor 130 are fixed, the level of the electrolyte 4 injected into the case 2 may be measured by measuring the distance between the level sensor 130 and the electrolyte 4.

Because the level sensor 130 measures the level of the electrolyte 4 through the inlet 2a of the case 2, the level sensor 130 needs to be spaced apart from the inlet 2a of the case 2 when the electrolyte 4 is injected into the case 2. By moving the tray 110 up and down and controlling the sensor mover 131 to move the level sensor 130 toward or away from the inlet 2a of the case 2, the controller 180 may position either the first hopper 120 or the level sensor 130 at the inlet 2a of the case 2.

The controller 180 may be configured to receive the level of the electrolyte 4 injected into the case 2 from the level sensor 130 and measure the degree of impregnation of the electrolyte in the case based on the level of the electrolyte 4. The degree of impregnation may mean the extent to which the electrolyte 4 permeates into the electrode assembly 3. When the electrolyte 4 is sufficiently impregnated into the cathode 3a or the anode 3c of the electrode assembly 3, a battery with favorable performance may be manufactured. When the degree of impregnation of the electrolyte 4 is poor, the performance of the battery may be reduced. After a predetermined amount of the electrolyte 4 is injected into the case 2, if the degree of impregnation is favorable, the level of the electrolyte 4 may be low because the electrolyte 4 permeates much into the cathode 3a or the anode 3c. If the degree of impregnation is unfavorable, the level of the electrolyte 4 may be high because the amount of the electrolyte 4 impregnated into the cathode 3a or the anode 3c is small. The controller 180 may be configured to compare the set reference level with the level of the electrolyte 4 injected into the case 2 received from the level sensor 130 and, when the level of the electrolyte 4 injected into the case 2 is greater than the set reference level, to determine that the degree of impregnation is poor.

The controller 180 may comprise a processor capable of executing program code and a storage configured to be connected to the processor for data transmission and reception. The processor may comprise a CPU, GPU, ASIC, or other data-processing devices. The storage may store program code written to perform a method of injecting the electrolyte 4 into the battery cell 1 according to an embodiment, the reference level, types of vibration applied according to levels, and other data or commands. By reading and executing the program code stored in the storage, the processor may perform the method of injecting the electrolyte 4 into the battery cell 1.

The controller 180 may further comprise an input/output interface connected to the processor for data transmission and reception, or a communication interface connected to the processor for data transmission and reception. The input/output interface may comprise input and output devices. The input devices may comprise a keyboard, mouse, touchpad, touchscreen, buttons, switches, and the like used by a user to input data or commands to the controller 180. The output devices may comprise a display, speaker, lamp, printer, and the like to provide data or information to the user. The communication interface may comprise communication components, circuits, antennas, and the like for transmitting and receiving data with a manufacturing process management system that manages the manufacturing process of the battery cell 1 or other computer devices. The communication interface may use various communication methods such as LAN, WAN, Ethernet, IPv4, IPv6, 5G, 6G, LTE, Bluetooth, Wi-Fi, Zigbee, and the like.

The second hopper 150 may be located outside the chamber 140. A plurality of second hoppers 150 may be arranged to correspond to the number of trays 110. The second hopper 150 may store the electrolyte 4. The electrolyte 4 stored in the second hopper 150 may be provided to the first hopper 120 through a valve 151. The valve 151 may be opened or closed in accordance with a control signal from the controller 180. The valve 151 may comprise a metering valve 151 that outputs a predetermined amount of electrolyte.

The chamber 140 may house a plurality of trays 110, level sensors 130, and sensor movers 131, and may comprise the first hopper 120 disposed across the inside and outside of the chamber 140. A vacuum line 141 may be connected to one side of the chamber 140. The vacuum line 141 may be connected to a vacuum generator. The vacuum generator may operate based on control by the controller 180 to form a vacuum inside the chamber 140.

To inject the electrolyte 4 into the case 2, the controller 180 may control the valve 151 to move a predetermined amount of electrolyte 4 from the second hopper 150 to the first hopper 120. The controller 180 may control the sensor mover 131 to move the level sensor 130 apart from the inlet 2a of the case 2. The controller 180 may move the tray 110 upward such that the outlet 122 of the first hopper 120 is inserted into the inlet 2a of the case 2. The controller 180 may control the vacuum generator to form a vacuum inside the chamber 140. When a vacuum is formed inside the chamber 140, the electrolyte 4 stored in the first hopper 120 may be injected into the case 2. The vacuum formed inside the chamber 140 may facilitate the electrolyte 4 to permeate into the electrode assembly 3. When the electrolyte 4 stored in the first hopper 120 is completely injected into the case 2, the controller 180 may move the tray 110 downward. The controller 180 may control the sensor mover 131 to move the level sensor 130 to the inlet 2a of the case 2. The level sensor 130 may measure the level of the electrolyte 4 injected into the case 2 and provide the measured level to the controller 180. The controller 180 may measure the degree of impregnation of the electrolyte based on the level of the electrolyte 4 received from the level sensor 130.

The injecting apparatus 1 may further comprise at least one weight sensor 160 connected to a portion of the tray 110 at which the case 2 is received to measure the weight of the case 2. The controller 180 may be configured to measure the weight of the electrolyte 4 injected into the case 2 using the weight of the case received from the weight sensor 160, and when the amount of the electrolyte 4 injected into the case 2 is smaller than a reference, to additionally supply the electrolyte 4.

The weight sensor 160 may comprise a weight-measuring sensor such as a load cell. The weight sensor 160 may be located in the receiving portion 111 of the tray 110. The weight sensor 160 may measure the weight of the case 2 and provide the measured weight to the controller 180. The weight sensor 160 may measure the weight of the case 2 before the electrolyte 4 is injected into the case 2. The weight sensor 160 may measure the weight of the case 2 after the electrolyte 4 is injected into the case 2.

The controller 180 may be configured to calculate the weight of the electrolyte 4 by subtracting the weight of the case 2 before the electrolyte 4 is injected from the weight of the case 2 with the electrolyte 4 injected therein. Because the amount of the electrolyte 4 provided from the second hopper 150 to the first hopper 120 is controlled by the valve 151, it may be difficult to precisely control the predetermined amount of electrolyte. Therefore, to accurately measure the amount of the electrolyte 4 injected into the case 2, the controller 180 may be configured to determine whether the predetermined amount of electrolyte 4 has been injected on the basis of the weight of the electrolyte 4. The controller 180 may control the valve 151 and the first hopper 120 so as to additionally inject the electrolyte 4 when the amount of the electrolyte 4 injected into the case 2 is smaller than the reference. After additionally injecting the electrolyte 4 into the case 2, the controller 180 may be configured to measure the weight of the case 2 using the weight sensor 160, and then calculate the weight of the electrolyte 4 again. When the weight of the electrolyte 4 reaches the set reference, the controller 180 may be configured to measure the level of the electrolyte 4.

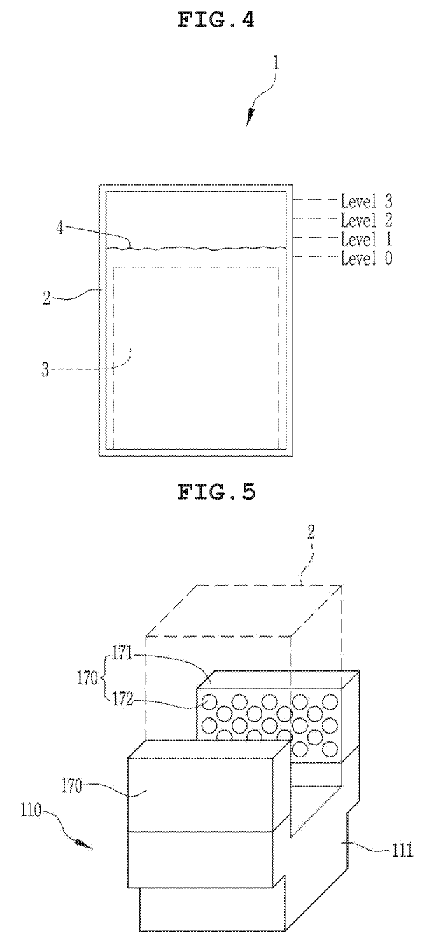

FIG. 4 is a diagram illustrating that the controller 180 determines the level of the electrolyte 4 as one of a plurality of preset levels according to an embodiment.

The controller 180 may determine whether the extent to which the level of the electrolyte 4 injected into the case 2 exceeds the reference level corresponds to one of a plurality of preset levels. The controller 180 may determine the extent to which the level of the electrolyte 4 exceeds the reference level and classify the extent into a plurality of preset levels. For example, there may be three preset levels. The number of preset levels may be two or four or more. The controller 180 may be configured to compare the level of the electrolyte 4 with the reference level and to compare the level of the electrolyte 4 with boundary levels that separate the preset levels.

When the level of the electrolyte injected into the case 2 exceeds the reference level and is equal to or less than a first-level of boundary level, the controller 180 may determine the level as a first level. When the level of the electrolyte injected into the case 2 exceeds the first-level of boundary level and is equal to or less than a second-level of boundary level, the controller 180 may determine the level as a second level. When the level of the electrolyte injected into the case 2 exceeds the second-level of boundary level, the controller 180 may determine the level as a third level. In this manner, the controller 180 may determine the level category of the level of the electrolyte 4 injected inside the case 2.

In the case of the first level, the controller 180 may determine that the degree of impregnation of the electrolyte is favorable. In the case of the second level, the controller 180 may determine that the degree of impregnation of the electrolyte is less favorable than the first level. In the case of the third level, the controller 180 may determine that the degree of impregnation of the electrolyte is less favorable than the second level. The controller 180 may display the degree of impregnation of the electrolyte to a user by level, or may convert the degree of impregnation corresponding to the level into a set numerical value for display. If the degree of impregnation is unfavorable, the user may decide to perform additional processes to improve the degree of impregnation. The user may also improve the electrolyte 4 injection process using the level data of the electrolyte 4.

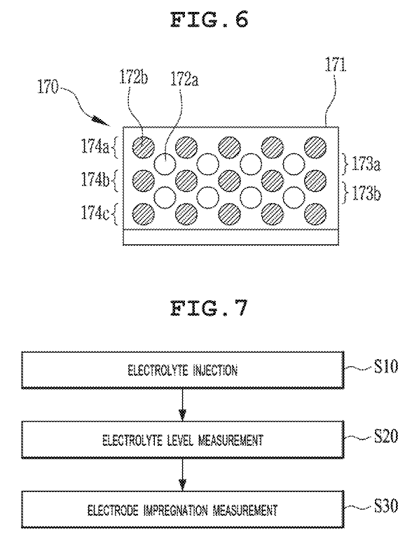

FIG. 5 is a diagram illustrating a vibration applying section 170 connected to the tray 110 according to an embodiment. FIG. 6 is a diagram illustrating a plurality of vibrators 172 of the vibration applying section 170 according to an embodiment.

The injecting apparatus 1 may further comprise a vibration applying section 170 connected to the tray 110, in contact with a side surface of the case 2, and configured to apply ultrasonic vibration to the case 2. The controller 180 may control the vibration applying section 170 to apply ultrasonic vibration to the case 2 when the level of the electrolyte 4 injected into the case 2 exceeds the reference level.

The vibration applying section 170 may apply vibration to the case 2. The vibration applying section 170 may output vibration under control of the controller 180. The vibration applying section 170 may be connected to the tray 110. The vibration applying section 170 may be formed one on each of both sides of the receiving portion 111 of the tray 110 to contact both sides of the case 2. The vibration applying section 170 may apply ultrasonic vibration to the case 2.

The vibration applying section 170 may comprise a wall 171 connected to the tray 110 and extending to a middle portion of the case 2 therefrom along an outer side of the case, and a plurality of vibrators 172 connected to the wall 171 to face the case 2.

A lower end of the wall 171 may be connected to the tray 110. An upper end of the wall 171 may be located at the middle level of the case 2. A height of the wall 171 may be, as a whole, about half or slightly more than half of the height of the case 2. The height of the wall 171 may also be similar to the height of the case 2. When the height of the wall 171 is low, vibration may be applied to a lower portion of the case 2, and when the height of the wall 171 is high, vibration may be applied to the middle and upper portions of the case 2. The height of the wall 171 may be determined according to an area in the case 2 to which vibration is to be applied.

The vibrators 172 may be connected to the wall 171 facing the case 2. A plurality of vibrators 172 may be connected to the wall 171. The plurality of vibrators 172 may apply vibration to the case 2 on the basis of control by the controller 180. When the vibrators 172 apply vibration to the case 2, vibration may be transmitted to the electrolyte 4 injected into the case 2. When vibration is applied to the electrolyte 4, the electrolyte 4 may permeate better into the electrode assembly 3. Recently, as part of methods for improving power density, there is a tendency to increase the amount of active material loaded in the electrodes, the compression ratio of active material, and the density of the electrode assembly 3. Although these trends may improve power density, they may act to lower the impregnability of the electrolyte 4. According to an embodiment, by providing vibration to the case 2 using the vibrators 172, the cathode 3a, separator 3b, and anode 3c may be at least temporarily separated from each other, thereby providing gaps therebetween into which the electrolyte 4 may permeate. Therefore, when the vibrators 172 operate, the degree of impregnation may be improved.

After determining whether the extent to which the level of the electrolyte 4 injected into the case 2 exceeds the reference level corresponds to one of a plurality of preset levels, the controller 180 may control the vibration applying section 170 to apply vibration to the case 2 in response to the preset level corresponding to the level of the electrolyte 4 injected into the case 2. For example, when the extent to which the level of the electrolyte 4 injected into the case 2 exceeds the reference level corresponds to a first preset level, the controller 180 may control the vibration applying section 170 to apply a first-level of vibration. When the extent corresponds to a second preset level greater than the first level, the controller 180 may control the vibration applying section 170 to apply a second-level of vibration. When the extent corresponds to a third preset level greater than the second level, the controller 180 may control the vibration applying section 170 to apply a third-level of vibration.

The first-level of vibration, the second-level of vibration, and the third-level of vibration may be set with different vibration intensities, frequencies, and application times. As the level increases, the vibration intensity and the vibration application time may increase. The vibration frequency may be set differently according to the level. For example, the second-level of vibration may have greater vibration intensity or application time than the first-level of vibration. The third-level of vibration may have greater vibration intensity or application time than the second-level of vibration. Because a higher level determined by the controller 180 indicates a poorer degree of impregnation, the controller 180 may set the vibration applied to the case 2 to be greater for higher levels. A poor degree of impregnation may be interpreted as an environment in which it is difficult for the electrolyte 4 to permeate between the cathode 3a, separator 3b, and anode 3c due to the high density of the electrode assembly 3. When the controller 180 applies stronger or longer vibration to the case 2, gaps may be formed between the cathode 3a, separator 3b, and anode 3c. The electrolyte 4 may permeate into the gaps formed temporarily by vibration, and the degree of impregnation may be improved.

The plurality of vibrators 172 may comprise a plurality of first vibrators 172a configured to apply a first frequency range of vibration, and a plurality of second vibrators 172b configured to apply a second frequency range of vibration whose frequency range is higher than the first range of vibration. The first vibrators 172a may output a relatively low-frequency range of vibration. For example, the first vibrators 172a may output vibration with a frequency from 10 Hz to 1 kHz. The second vibrators 172b may output a relatively high-frequency range of vibration. For example, the second vibrators 172b may output vibration with a frequency from 100 Hz to 10 kHz. The first vibrators 172a and the second vibrators 172b may output vibration at frequencies in response to control signals provided by the controller 180. The frequencies of the vibration output by the vibrators 172 may be set differently according to the design of the electrodes and the active material.

The vibration output by the vibrator 172 may be determined to be at a frequency at which an active material layer does not separate from a current collector and no cracks occur in the active material layer.

The plurality of first vibrators 172a may be arranged in a row so that the first vibrators 172a are spaced apart from each other. The plurality of second vibrators 172b may be arranged in a row so that the second vibrators 172b are spaced apart from each other. For example, the plurality of first vibrators 172a may be arranged in two rows 173a and 173b of first vibrators 172a located at the middle-lower portion and middle-upper portion of the wall 171 so that the first vibrators 172a are spaced apart at regular intervals, and the plurality of second vibrators 172b may be arranged in three rows 174a, 174b, and 174c of second vibrators 172b located at the lower, middle, and upper portions of the wall 171 so that the second vibrators 172b are spaced apart at regular intervals. To provide effective vibration for improving the degree of impregnation in the case 2, the number, location, and arrangement of the rows of first and second vibrators may be changed. Depending on the locations or number of the rows of first and second vibrators, the magnitude, duration, and frequency of the first-level, second-level, and third-level of vibrations may be set variously.

The first-level of vibration may be such that the vibration by the two rows 173a and 173b of first vibrators 172a is applied to the case 2 for a first period of time. The second-level of vibration may be such that the vibration by the two rows 174a and 174b of second vibrators 172b located at the upper and middle portions of the wall 171 is applied to the case 2 for a second period of time, and sequentially, the vibration by the two rows 173a and 173b of first vibrators 172a is applied to the case 2 for a third period of time. The third-level of vibration may be such that vibration by the row 174a of second vibrator 172b located at the upper portion of the wall 171 and vibration by the two rows 173a and 173b of first vibrators 172a are applied to the case 2 for a fourth period of time, and subsequently, vibration by the two rows 174b and 174c of second vibrators 172b located at the middle and lower portions of the wall 171 is applied to the case 2 for a fifth period of time, and vibration by the two rows 173a and 173b of first vibrators 172a is applied to the case 2 for a sixth period of time.

The first-level of vibration is such that vibration output by the first vibrators 172a is applied to the case 2. Because the two rows 173a and 173b of first vibrators 172a are located at the middle-lower and middle-upper portions of the wall 171, vibration may be applied to a position corresponding overall to the lower portion of the case 2. Because the first level exhibits a more favorable degree of impregnation than the second or third level, vibration may be applied at a lower frequency and for a relatively shorter time. In the first-level of vibration, the first period of time may be about 60 seconds. The first period of time may be set differently.

The second-level of vibration may be such that the rows 174a, 174b, and 174c of second vibrators 172b operate for the second period of time and then the rows 173a and 173b of first vibrators 172a operate for the third period of time. The second-level of vibration may have a vibration pattern in which high-frequency vibration is applied first and low-frequency vibration is applied later. The second-level of vibration may be such that in the two rows 174a, 174b, and 174c of second vibrators 172b, those located at the upper and middle portions 174a and 174b of the wall 171 may operate, and the rest located at the lower portion 174c of the wall 171 may not operate. The second-level of vibration may be such that both the rows 173a and 173b of first vibrators 172a located at the middle-upper and middle-lower portions of the wall 171 operate. The second period of time may be 30 seconds, and the third period of time may be 60 seconds. The second and third period of times may be set differently. Depending on the characteristics of the electrode assembly 3, the first vibrators 172a may operate first and the second vibrators 172b may operate later.

When the two rows 174a and 174b of second vibrators 172b located at the upper and middle portions of the wall 171 operate, high-frequency vibration may be applied to the middle portion of the case 2. Therefore, gaps may be easily formed in the electrode assembly 3. Subsequently, when the rows 173a and 173b of first vibrators 172a located at the middle-upper and middle-lower portions of the wall 171 operate, gaps may also easily formed in the electrode assembly 3 at those portions in a different manner. Therefore, the electrolyte 4 may permeate better into the gaps, and the degree of impregnation may be further improved.

The third-level of vibration is such that high-frequency vibration and low-frequency vibration are applied simultaneously to the case 2, then high-frequency vibration is applied to the case 2, and finally low-frequency vibration is applied to the case 2. The fact that the level of the electrolyte 4 is the third preset level means that the degree of impregnation is low. By simultaneously applying low-frequency and high-frequency vibrations to the case 2, gaps may be easily formed in the electrode assembly 3. Accordingly, the electrolyte 4 may permeate better into the gaps so that the degree of impregnation may be improved. The fourth period of time may be 60 seconds, the fifth period of time may be 30 seconds, and the sixth period of time may be 60 seconds. The fourth to sixth period of times may be set differently.

A reason for a poor degree of impregnation may be that the electrolyte 4 permeates less into a middle portion of the electrode assembly 3 than upper and lower portions corresponding to edges of the electrode assembly 3. Therefore, when the level is high, the vibration applying section 170 may be controlled to apply strong and composite vibration to the middle portion of the case 2. Accordingly, the third-level of vibration may be applied in such a way that the row 174a of second vibrators 172b located at the upper portion of the wall 171 and the rows 173a and 173b of first vibrators 172a located at the middle-upper and middle-lower portions of the wall 171 operate simultaneously to apply composite-frequency vibration to the middle portion of the case 2. Next, the third-level of vibration may be applied in such a way that the two rows 174b and 174c of second vibrators 172b at the middle and lower portions of the wall 171 operate to apply high-frequency vibration to the middle-lower portion of the case 2. Finally, the third-level of vibration may be applied in such a way that the rows 173a and 173b of first vibrators 172a located at the middle-upper and middle-lower portions of the wall 171 operate to apply low-frequency vibration to the lower portion of the case 2. Accordingly, gaps may be formed in the middle and middle-lower portions of the electrode assembly 3, so that the electrolyte 4 may permeate into the gaps, and the degree of impregnation may be improved.

FIG. 7 is a diagram illustrating a method of injecting an electrolyte 4 into a battery cell 1 according to an embodiment.

The method may comprise step S10 of injecting, by a first hopper 120, the electrolyte 4 into the case 2 while the case 2 with the electrode assembly 3 accommodated therein is received in the tray 110; step S20 of measuring, by a level sensor 130, the level of the electrolyte 4 injected into the case 2; and step S30 of receiving, by a controller 180, the level of the electrolyte 4 from the level sensor 130 and measuring the degree of impregnation of the electrolyte in the case by comparing the level of the electrolyte 4 with a reference level.

In step S10, the electrolyte 4 is injected into the case 2 from the first hopper 120. In step S10, the case 2 may be received in the tray 110, a predetermined amount of electrolyte 4 may be stored in the first hopper 120, an outlet 122 of the first hopper 120 may be inserted into an inlet 2a of the case 2, and the electrolyte 4 may be injected into the case 2 from the first hopper 120.

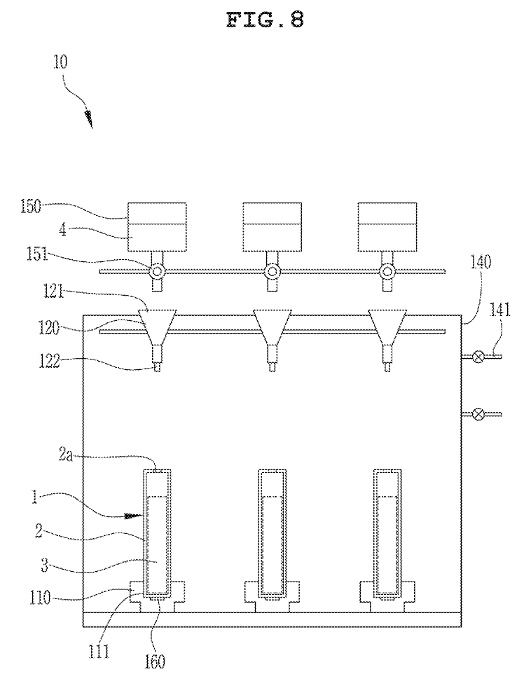

The step S10 of injecting the electrolyte 4 will be described with reference to FIGS. 8-11.

FIG. 8 is a diagram illustrating a state in which the case 2 is received in the tray 110.

The case 2 may be inserted into the receiving portion 111 of the tray 110 located inside the chamber 140. The electrode assembly 3 may be accommodated in the case 2. The case 2 may be a case 2 of a prismatic battery cell 1 or a case 2 of a cylindrical battery cell 1. The inlet 2a on the upper surface of the case 2 may be in an open state. The tray 110 may be in a lowered state to allow the case 2 to be inserted into the tray 110. When the case 2 is received in the lowered tray 110, the case 2 and the first hopper 120 may be spaced apart.

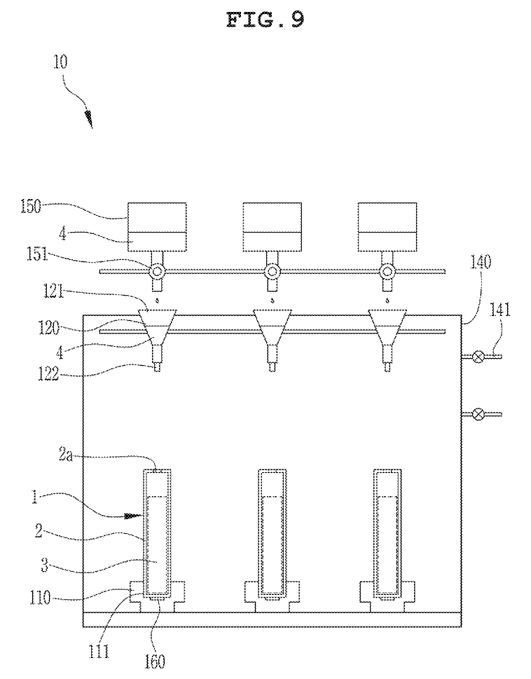

FIG. 9 is a diagram illustrating a state in which a predetermined amount of electrolyte 4 has been moved from the second hopper 150 to the first hopper 120.

The controller 180 may control a valve 151 to move a predetermined amount of electrolyte 4 from the second hopper 150 to the first hopper 120. The valve 151 may be opened for a predetermined time and then closed, so that a portion of the electrolyte 4 stored in the second hopper 150 moves to the inlet 121 of the first hopper 120. The controller 180 may adjust the time the valve 151 is open to control the amount of electrolyte 4.

For the first hopper 120 and the inlet 2a of the case 2 to be connected, the level sensor 130 need not to be present between the first hopper 120 and the case 2. The step S10 of injecting the electrolyte 4 may be performed in a state in which the level sensor 130 is kept spaced apart from the inlet 2a while the controller 180 controls a sensor mover 131 to move the level sensor 139 to the inlet 2a formed in the case so that the first hopper 120 injects the electrolyte 4 through the inlet 2a. The controller 180 may control the sensor mover 131 to move the level sensor 130 away from the case 2 immediately after performing the level measurement.

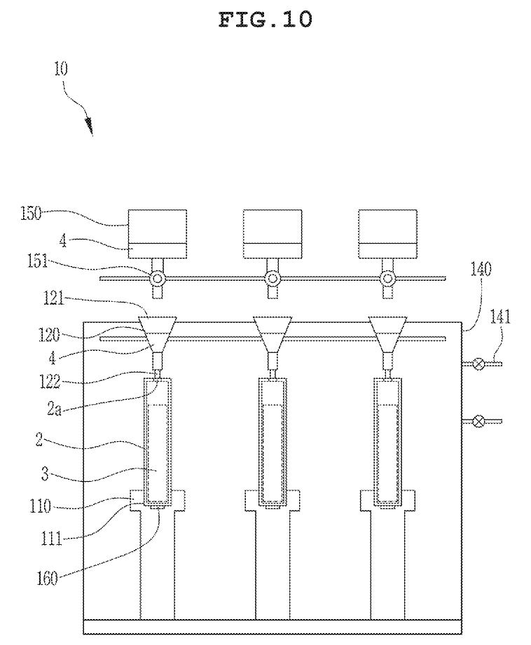

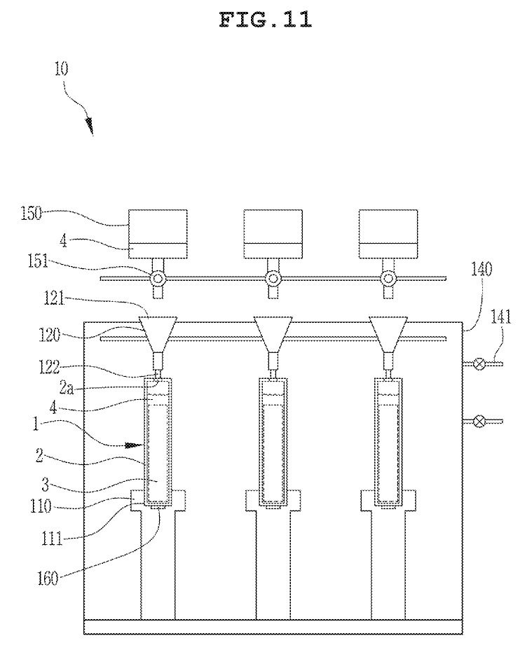

FIG. 10 is a diagram illustrating a state in which the tray 110 moves upward and the first hopper 120 and the inlet 2a of the case 2 are connected.

The controller 180 may move the tray 110 upward to insert the outlet 122 of the first hopper 120 into the inlet 2a of the case 2. When the tray 110 is moved upward, the outlet 122 of the first hopper 120, which is positioned above the inlet 2a of the case 2, may be inserted into the inlet 2a. Because the height of the case 2 and the position of the outlet of the second hopper 150 are determined according to the type of case 2, the controller 180 may control the tray 110 to be moved upward by a set height.

FIG. 11 is a diagram illustrating a state in which the electrolyte 4 is injected from the first hopper 120 into the case 2.

The controller 180 may control a vacuum generator connected via a vacuum line 141 such that the interior of the chamber 140 becomes a vacuum. When the interior of the chamber 140 becomes a vacuum, the electrolyte 4 stored in the first hopper 120 may move into the inlet 2a of the case 2 by atmospheric pressure. When the electrolyte 4 is fully injected, the controller 180 may block the outlet 122 of the first hopper 120. When the interior of the chamber 140 becomes a vacuum, the interior of the case 2 also becomes a vacuum, and because there is no air between the cathode 3a, separator 3b, and anode 3c of the electrode assembly 3, the electrolyte 4 may permeate well.

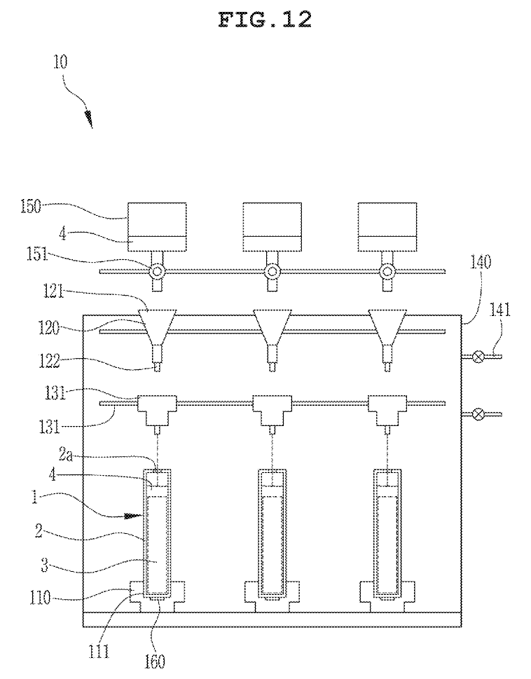

FIG. 12 is a diagram illustrating a state in which the tray 110 moves downward and the level sensor 130 measures the level of the electrolyte 4 injected into the case 2.

The step S20 of measuring the level of the electrolyte 4 may be performed after the controller 180 moves the tray 110 downward. The step S20 of measuring the level of the electrolyte 4 may be performed while the controller 180 controls the sensor mover 131 to move the level sensor 130 to the inlet 2a.

In the step S20 of measuring the level of the electrolyte 4, the controller 180 may move the tray 110 downward. When the tray 110 is moved downward, the outlet 122 of the first hopper 120 may be disengaged from the inlet 2a of the case 2. Then, the first hopper 120 and the case 2 may be spaced apart to form a space where the level sensor 130 may be positioned. The controller 180 may control the sensor mover 131 to position the level sensor 130 above the inlet 2a of the case 2. The level sensor 130 may measure the level of the electrolyte 4 through the inlet 2a. The level sensor 130 may measure the level of the electrolyte 4 and provide the measured level to the controller 180.

The step S30 of measuring the degree of impregnation is to measure the degree of impregnation by comparing, by the controller 180, the level of the electrolyte 4 received from the level sensor 130 with a reference level. The controller 180 may compare the set reference level with the level of the electrolyte 4 injected into the case 2, which is received from the level sensor 130, and when the level of the electrolyte 4 injected into the case 2 is greater than the set reference level, determine that the degree of impregnation is poor.

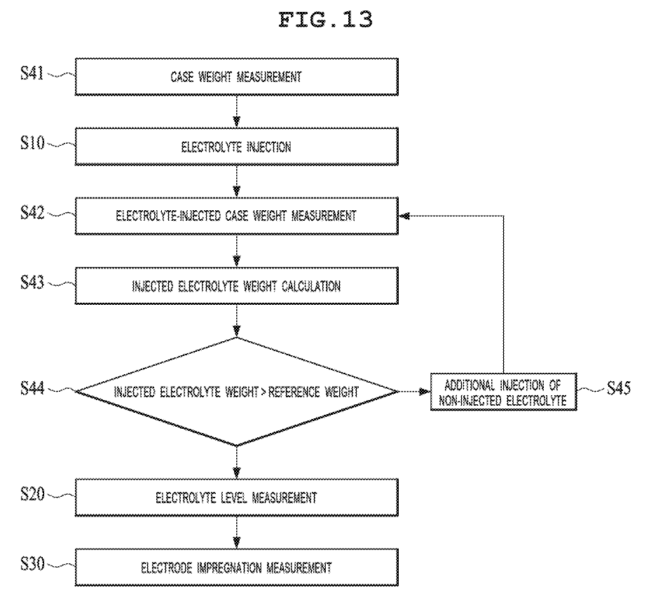

FIG. 13 is a diagram illustrating a process of checking the injection amount of the electrolyte 4 using the weight sensor 160 in the method of injecting the electrolyte 4 into the battery cell 1 according to an embodiment. The process is described with reference to FIG. 13, together with FIGS. 1 and 8-12.

To accurately measure the degree of impregnation by measuring the level of the electrolyte 4, a predetermined amount of electrolyte 4 should be injected accurately in the step S10 of injecting the electrolyte 4. Therefore, in the method of injecting the electrolyte 4 into the battery cell 1, the amount of the electrolyte 4 injected during the step S10 of injecting the electrolyte 4 may be checked by the weight sensor 160.

The method of injecting the electrolyte 4 into the battery cell 1 may further comprise step S41 of measuring, by the weight sensor 160 connected to a portion of the tray 110 at which the case 2 is received, the weight of the case 2 before the electrolyte 4 is injected into the case 2, step S42 of measuring, by the weight sensor 160, the weight of the case 2 with the electrolyte 4 injected therein after the electrolyte 4 is injected into the case 2, step S43 of calculating, by the controller 180, the weight of the electrolyte 4 injected into the case 2 by subtracting the weight of the case 2 before injection of the electrolyte from the weight of the case 2 with the electrolyte 4 injected therein, which is received from the weight sensor 160, step S44 of comparing, by the controller 180, the weight of the electrolyte 4 injected into the case 2 with a reference weight, and, when the weight of the electrolyte 4 is smaller than the reference weight, step S45 of additionally injecting, by controlling the first hopper 120, an amount of the electrolyte 4 corresponding to the difference between the weight of the electrolyte 4 and the reference weight. After performing the step S45 of additionally injecting the electrolyte 4, the step S42 of measuring the weight of the case 2 with the electrolyte 4 injected therein may be performed. When the weight of the electrolyte 4 is equal to or greater than the reference weight, the controller 180 may perform the step S20 of measuring the level of the electrolyte 4.

The step S41 of measuring the weight of the case 2 may be performed when the case 2 is inserted into the tray 110. Before the electrolyte 4 is injected into the case 2 with the electrode assembly 3 accommodated therein, the weight sensor 160 may measure the weight of the case and provide the measured weight to the controller 180.

Then, the controller 180 may perform the step S10 of injecting the electrolyte 4 into the case 2, and when the electrolyte 4 stored in the first hopper 120 is injected into the case 2, the controller may perform the step S42 of measuring the weight of the case 2 with the electrolyte 4 injected therein.

The step S42 of measuring the weight of the case 2 with the electrolyte 4 injected therein may be performed in a state in which the tray 110 has been moved upward. When an additional injection of the electrolyte 4 is necessary, it may not be necessary to move the tray 110 again, which may help shorten process time. The weight sensor 160 may measure the weight of the case 2 with the electrolyte 4 injected therein and provide the measured weight to the controller 180.

The step S43 of calculating the weight of the electrolyte 4 is to calculate, by the controller 180, the weight of the electrolyte 4 by subtracting the weight of the case 2 before the electrolyte 4 is injected from the weight of the case 2 with the electrolyte 4 injected therein. When the weight of the electrolyte 4 is calculated, the exact amount of the electrolyte 4 injected into the case 2 may be checked. Because the amount of the electrolyte 4 moved by adjusting the opening and closing of the valve 151 may not be accurate, the amount of the electrolyte 4 is measured again accurately using weight measurement.

The step S44 of comparing the weight of the electrolyte 4 with the reference weight is to compare, by the controller 180, the weight of the electrolyte 4 injected into the case 2 with the reference weight. The reference weight is a value set as the weight of the electrolyte 4 to be injected into the case 2. When the electrolyte 4 is smaller than the reference weight, an additional injection of the electrolyte 4 is required because a sufficient amount of the electrolyte 4 is needed to improve the degree of impregnation.

The step S45 of additionally injecting the electrolyte 4 may be performed when the weight of the electrolyte 4 is smaller than the reference weight. In the step S45 of additionally injecting the electrolyte 4, the controller 180 may control the first hopper 120 to additionally supply the electrolyte 4 in an amount corresponding to the difference between the weight of the electrolyte 4 and the reference weight. The controller 180 may control the valve 151 to move the electrolyte 4 from the second hopper 150 to the first hopper 120 in the amount to be additionally injected, and may open the outlet 122 of the first hopper 120 to inject the electrolyte 4 into the case 2.

After additionally injecting the electrolyte 4, the controller 180 may perform again the step S42 of measuring the weight of the case 2 with the electrolyte 4 injected therein. The controller 180 may then calculate again the weight of the electrolyte 4 and compare the calculated weight with the reference weight. When the weight of the electrolyte 4 is equal to or greater than the reference weight, the controller 180 may perform the step S20 of measuring the level of the electrolyte 4.

If the degree of impregnation is measured while the electrolyte 4 is injected in an amount less than the predetermined amount, a problem may occur in which the level is derived as low although the degree of impregnation is actually low. As described, by checking, using the weight sensor 160, whether the predetermined amount of electrolyte 4 has been injected, and then measuring the level of the electrolyte 4, the degree of impregnation may be checked more accurately.

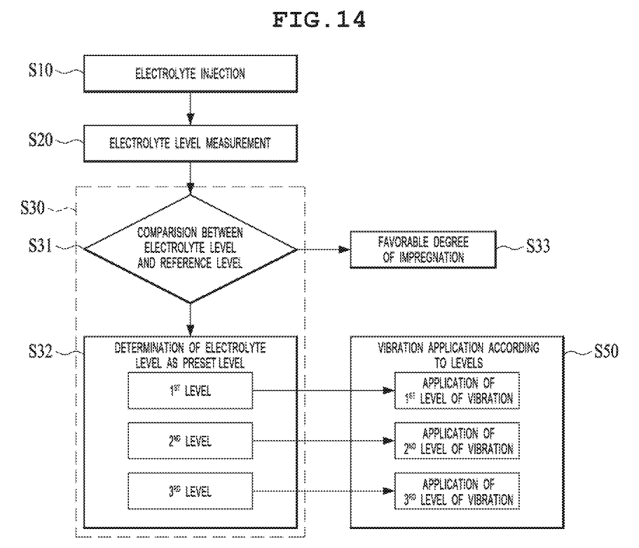

FIG. 14 is a diagram illustrating a process of improving the degree of impregnation using the vibration applying section 170 in the method of injecting the electrolyte 4 into the battery cell 1 according to an embodiment. The process is described with reference to FIG. 14 together with FIGS. 5 and 6.

The step S30 of measuring the degree of impregnation may comprise step S31 of comparing, by the controller 180, the level of the electrolyte 4 injected into the case 2 with the reference level, and step S32 of determining, by the controller 180, the level of the electrolyte 4 as one of a plurality of preset levels.

The step S31 of comparing the level of the electrolyte 4 with the reference level is to compare, by the controller 180, the level of the electrolyte 4 received from the level sensor 130 with the preset reference level. When the level of the electrolyte 4 is equal to or less than the reference level, the controller 180 may determine that the degree of impregnation is favorable (S33).

When the level of the electrolyte 4 exceeds the reference level, the controller 180 may perform the step S32 of determining the level of the electrolyte 4 as one of a plurality of preset levels. The plurality of levels is preset. The higher the level, the more the level of the electrolyte 4 exceeds the reference level. Because the level of the electrolyte 4 exceeding the reference level means that the degree of impregnation is poor, vibration may be applied to the case 2 to improve the degree of impregnation.

When the level of the electrolyte 4 exceeds the reference level and is equal to or less than a first-level boundary, the controller 180 may determine the level of the electrolyte as the first level. When the level of the electrolyte 4 exceeds the first-level boundary and is equal to or less than a second-level boundary, the controller 180 may determine the level of the electrolyte as the second level. When the level of the electrolyte 4 exceeds a third-level boundary, the controller 180 may determine the level of the electrolyte as the third level. The reference level, the first-level boundary, the second-level boundary, and the third-level boundary may vary depending on the type, size, and design of the battery cell 1, and the characteristics of the electrode assembly 3 and the electrolyte 4.

The method of injecting the electrolyte 4 into the battery cell 1 may further comprise step S50 of applying, by controlling the vibration applying section 170 connected to the tray 110, in contact with a side surface of the case 2, and configured to apply ultrasonic vibration to the case 2, vibration to the case 2 according to the level.

The step S50 of applying vibration may be performed according to the degree of impregnation measured in the step S30 of measuring the degree of impregnation. In the step S50 of applying vibration, the controller 180 may operate the vibration applying section 170 to apply vibration to the case 2. When vibration is applied to the case 2, the electrolyte 4 injected into the case 2 and the electrode assembly 3 may also vibrate. Because the electrode assembly 3 is in a stacked form of the cathode 3a, separator 3b, and anode 3c, such vibration may create gaps between the cathode 3a, separator 3b, and anode 3c of the electrode assembly so that the electrolyte 4 may permeate into the gaps. Therefore, the degree of impregnation may be improved by applying vibration while the electrolyte 4 is injected.

The controller 180 may control the vibration applying section 170 to apply vibration to the case 2 according to the level. For example, in the step S50 of applying vibration, when the extent to which the level of the electrolyte 4 injected into the case 2 exceeds the reference level corresponds to the first level, the controller 180 may control the vibration applying section 170 to apply a first-level of vibration; when the extent corresponds to a second level greater than the first level, the controller 180 may control the vibration applying section 170 to apply a second-level of vibration; and when the extent corresponds to a third level greater than the second level, the controller 180 may control the vibration applying section 170 to apply a third-level of vibration.

The vibration applied to the case 2 may be variously designed according to an arrangement structure of the vibrators 172 of the vibration applying section 170. The vibration applying section 170 may comprise a wall 171 connected to the tray 110 and extending to the middle portion of the case 2 therefrom, and a plurality of vibrators 172 connected to the wall 171 to face the case 2. The plurality of vibrators 172 may comprise a plurality of first vibrators 172a configured to apply a first frequency range of vibration, and a plurality of second vibrators 172b configured to apply a second frequency range of vibration whose frequency range is higher than the first range of vibration. In addition, the plurality of first vibrators 172a may be arranged in two rows 173a and 173b of first vibrators 172a located at the middle-lower portion and middle-upper portion of the wall 171 so that the first vibrators 172a are spaced apart at regular intervals, and the plurality of second vibrators 172b may be arranged in three rows 174a, 174b, and 174c of second vibrators 172b located at the lower, middle, and upper portions of the wall 171 so that the second vibrators 172b are spaced apart at regular intervals.

As described with reference to FIGS. 5 and 6, the first-level of vibration, the second-level of vibration, and the third-level of vibration may be set differently in terms of vibration locations, frequency ranges, intensity, and application times of the vibrators 172.

The first-level of vibration may be such that the vibration by the two rows 173a and 173b of first vibrators 172a is applied to the case 2 for a first period of time. The second-level of vibration may be such that the vibration by the two rows 174a and 174b of second vibrators 172b located at the upper and middle portions of the wall 171 is applied to the case 2 for a second period of time, and sequentially, the vibration by the two rows 173a and 173b of first vibrators 172a is applied to the case 2 for a third period of time. The third-level of vibration may be such that the vibration by the row 174a of second vibrators 172b located at the upper portion of the wall 171 and the vibration by the two rows 173a and 173b of first vibrators 172a are applied to the case 2 for a fourth period of time, and sequentially, the vibration by the two rows 174b and 174c of second vibrators 172b located at the middle and lower portions of the wall 171 is applied to the case 2 for a fifth period of time, and the vibration by the two rows 173a and 173b of first vibrators 172a is applied to the case 2 for a sixth period of time.

Specific details regarding the first-level, second-level, and third-level of vibrations have been described above, and therefore a repeated descriptions thereof will be omitted.

The present disclosure has been described in detail through specific embodiments. The above descriptions are merely examples applying the principles of the present disclosure, and other configurations may also be further comprised without departing from the scope of the present disclosure.

What is claimed is:

1. An apparatus for injecting an electrolyte into a battery cell, the apparatus comprising:
at least one tray provided to receive a case with an electrode assembly inserted therein;
at least one first hopper provided to inject the electrolyte into the case therethrough;
at least one level sensor provided to measure the level of the electrolyte injected into the case; and
a controller configured to be informed of the electrolyte level from the level sensors and to measure the degree of impregnation of the electrolyte by comparing the electrolyte level with a reference level.

2. The apparatus of claim 1, further comprising at least one weight sensor connected to a portion in the tray at which the case is received, the weight sensors being configured to measure the weight of the case, wherein the controller is configured to measure the weight of the electrolyte injected into the case using the weight received from the weight sensor, and when the amount of the electrolyte injected into the case is smaller than a reference amount, to allow for an additional supply of the electrolyte.

3. The apparatus of claim 1, further comprising a sensor mover provided to move the level sensor to an inlet formed in the case, wherein the controller is configured to control the sensor mover such that, while the first hopper injects the electrolyte through the inlet, the level sensor is spaced apart from the inlet, and after the first hopper injects the electrolyte, the level sensor is moved to the inlet.

4. The apparatus of claim 1, further comprising a vibration applying section connected to the tray and in contact with a side surface of the case, the vibration applying section being configured to apply ultrasonic vibration to the case, wherein the controller is configured to control the vibration applying section to apply ultrasonic vibration to the case when the level of the electrolyte injected into the case exceeds the reference level.

5. The apparatus of claim 4, wherein the controller is configured to determine whether the extent to which the level of the electrolyte injected into the case exceeds the reference level corresponds to one of a plurality of preset levels, and to control the vibration applying section to apply vibration to the case in response to the corresponding preset level.

6. The apparatus of claim 5, wherein the vibration applying section comprises:
a wall connected to the tray and extending to a middle portion of the case therefrom; and
a plurality of vibrators connected to the wall to face the case,
wherein the controller is configured to, when the extent to which the level of the electrolyte injected into the case exceeds the reference level corresponds to a first preset level, control the vibration applying section to apply a first-level of vibration, when the extent corresponds to a second preset level greater than the first preset level, control the vibration applying section to apply a second-level of vibration, and when the extent corresponds to a third preset level greater than the second level, control the vibration applying section to apply a third-level of vibration.

7. The apparatus of claim 6, wherein the plurality of vibrators comprises:
a plurality of first vibrators provided to apply a first frequency range of vibration; and
a plurality of second vibrators provided to apply a second frequency range of vibration whose frequency range is higher than the first frequency range of vibration,
wherein the plurality of first vibrators are arranged in two rows of first vibrators located at the middle-lower portion and middle-upper portion of the wall so that the first vibrators are spaced apart at regular intervals, and the plurality of second vibrators is arranged in three rows of second vibrators located at the lower, middle, and upper portions of the wall so that the plurality of second vibrators is spaced apart at regular intervals,
wherein the first-level of vibration is such that the vibration by the two rows of first vibrators is applied to the case for a first period of time,
the second-level of vibration is such that the vibration by the two rows of second vibrators located at the upper and middle portions of the wall is applied to the case for a second period of time, and sequentially, the vibration by the two rows of first vibrators is applied to the case for a third period of time, and
the third-level of vibration is such that the vibration by the row of second vibrators located at the upper portion of the wall and the vibration by the two rows of first vibrators are applied to the case for a fourth period of time, and sequentially, the vibration by the two rows of second vibrators located at the middle and lower portions of the wall is applied to the case for a fifth period of time, and the vibration by the two rows of first vibrators is applied to the case for a sixth period of time.

8. A method of injecting an electrolyte into a battery cell, the method comprising:
while a case with an electrode assembly accommodated therein is received in a tray, injecting, through a first hopper, the electrolyte into the case;
measuring, by a level sensor, the level of the electrolyte injected into the case; and
receiving, by a controller, the electrolyte level from the level sensor and measuring the degree of impregnation of the electrolyte in the case by comparing the electrolyte level with a reference level.

9. The method of claim 8, further comprising:
before the electrolyte is injected into the case, measuring, by a weight sensor connected to a portion in the tray at which the case is received, the weight of the case;
after the electrolyte is injected into the case, measuring, by the weight sensor, the weight of the case with the electrolyte injected therein;
calculating, by the controller, the weight of the electrolyte injected into the case by subtracting the weight of the case before the electrolyte is injected into the case from the weight of the case after the electrolyte is injected into the case, which is received from the weight sensor;
comparing, by the controller, the weight of the electrolyte injected into the case with a reference weight; and, when the weight of the electrolyte is smaller than the reference weight; and
controlling, by the controller, the first hopper to additionally inject an amount of electrolyte corresponding to the difference between the weight of the electrolyte and the reference weight,
wherein after additional injection of the electrolyte, the controller is configured to measure the weight of the case with the electrolyte additionally injected therein, and when the weight of the electrolyte is equal to or greater than the reference weight, to measure the level of the electrolyte.

10. The method of claim 8, wherein the step of injecting the electrolyte is performed in a state in which the level sensor is kept spaced apart from an inlet formed in the case while the controller controls a sensor mover to move the level sensor to the inlet so that the first hopper injects the electrolyte through the inlet, and
the step of measuring the level of the electrolyte is performed while the controller controls the sensor mover to move the level sensor to the inlet.

11. The method of claim 8, wherein the step of measuring the degree of impregnation of the electrolyte comprises comparing, by the controller, the level of the electrolyte injected into the case with a reference level; and
determining, by the controller, the electrolyte level as one of a plurality of preset levels.

12. The method of claim 11, further comprising controlling, by the controller, a vibration applying section, connected to the tray and in contact with a side surface of the case, to apply ultrasonic vibration to the case in response to the determined preset level.

13. The method of claim 12, wherein the step of applying vibration comprises:
when the extent to which the level of the electrolyte injected into the case exceeds the reference level corresponds to a first preset level, controlling, by the controller, the vibration applying section to apply a first-level of vibration;
when the extent corresponds to a second preset level greater than the first preset level, controlling, by the controller, the vibration applying section to apply a second-level of vibration; and
when the extent corresponds to a third preset level greater than the second preset level, controlling, by the controller, the vibration applying section to apply a third-level of vibration.

14. The method of claim 13, wherein the vibration applying section comprises:
a wall connected to the tray and extending to a middle portion of the case therefrom; and
a plurality of vibrators connected to the wall to face the case, wherein the plurality of vibrators comprises:
a plurality of first vibrators provided to apply a first frequency range of vibration; and
a plurality of second vibrators provided to apply a second frequency range of vibration whose frequency range is higher than the first frequency range of vibration,
wherein the plurality of first vibrators are arranged in two rows of first vibrators located at the middle-lower portion and middle-upper portion of the wall so that the first vibrators are spaced apart at regular intervals, and the plurality of second vibrators is arranged in three rows of second vibrators located at the lower, middle, and upper portions of the wall so that the plurality of second vibrators is spaced apart at regular intervals,
wherein the first-level of vibration is such that the vibration by the two rows of first vibrators is applied to the case for a first period of time,
the second-level of vibration is such that the vibration by the two rows of second vibrators located at the upper and middle portions of the wall is applied to the case for a second period of time, and sequentially, the vibration by the two rows of first vibrators is applied to the case for a third period of time, and
the third-level of vibration is such that the vibration by the row of second vibrators located at the upper portion of the wall and the vibration by the two rows of first vibrators are applied to the case for a fourth period of time, and sequentially, the vibration by the two rows of second vibrators located at the middle and lower portions of the wall is applied to the case for a fifth period of time, and the vibration by the two rows of first vibrators is applied to the case for a sixth period of time.
